(19) United States
(12) Patent Application Publication
(10) Pub. No.: US 2005/0147414 A1
(43) Pub. Date: Jul. 7, 2005

(54) Low latency optical memory bus

(76) Inventors: Warren R. Morrow, Steilacoom, WA (US); Brandon C. Barnett, Beaverton, OR (US)

Correspondence Address: Jan Little-Washington;BLAKELY, SOKOLOFF, TAYLOR & ZAFMAN LLP, Seventh Floor, 12400 Wilshire Boulevard, Los Angeles, CA, 90025, US

(21) Appl. No.: 10/748,758

(22) Filed: Dec. 30, 2003

(51) Int. Cl. H04B 10/12

(52) U.S. Cl. 398/142

(57) ABSTRACT

Embodiments of the present invention include an integrated circuit to communicate with a memory device. The integrated circuit includes an optical transmitter and an optical bus coupled to the integrated circuit's optical transmitter. N optical receivers are coupled to the optical bus via N optical couplers. N memory modules are coupled to the N optical receivers. M memory devices are coupled to the N memory modules. The optical transmitter converts a signal to communicate with the N memory modules from an electrical signal to an optical signal. The optical bus propagates the optical signal. Each of the N optical couplers to couple a one-Nth of the optical signal from the optical bus to each one of the N optical receivers, each of the N optical receivers converts its one-Nth of the optical signal to an electrical signal for its associated memory device.

### BACKGROUND

1. Field

Embodiments of the present invention relate to memory circuits and particularly to memory buses.

2. Discussion of Related Art

A common computer chipset includes a processor electrically coupled to a memory controller via a front side bus. The memory controller is electrically coupled to one or more memory modules via a memory bus. The memory modules plug into the memory bus and memory devices plug into the memory modules. The processor can read from the memory devices and/or write to the memory devices. For efficient operation of the chipset, the processor should have high-speed access to the memory devices. As technology advances, it is common to increase the speed of the memory bus to improve the performance of the chipset.

One memory bus architecture that supports faster bus speeds uses multiple memory modules. In this architecture, several memory modules can be plugged into the memory bus for each memory channel that the memory controller supports.

This memory bus architecture has limitations, however. For example, plugging multiple memory modules into the bus causes impedance discontinuities. Impedance discontinuities can cause electrical noise and time delays due to signal reflections. One way to reduce impedance discontinuities issues is to buffer the memory modules. Buffering adds latency, however, which is a performance limiter as well.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high level schematic diagram of a memory subsystem according to an embodiment of the present invention;

FIG. 2 is a flowchart illustrating a method for operating the memory subsystem in FIG. 1 according to an embodiment of the present invention;

FIG. 3 is a flowchart illustrating a method for operating the memory subsystem in FIG. 1 according to an alternative embodiment of the present invention;

FIG. 4 is a high-level block diagram of a computer system according to an embodiment of the present invention; and

FIG. 5 is a high level schematic diagram of a memory subsystem according to an alternative embodiment of the present invention.

### DETAILED DESCRIPTION OF THE ILLUSTRATED EMBODIMENTS

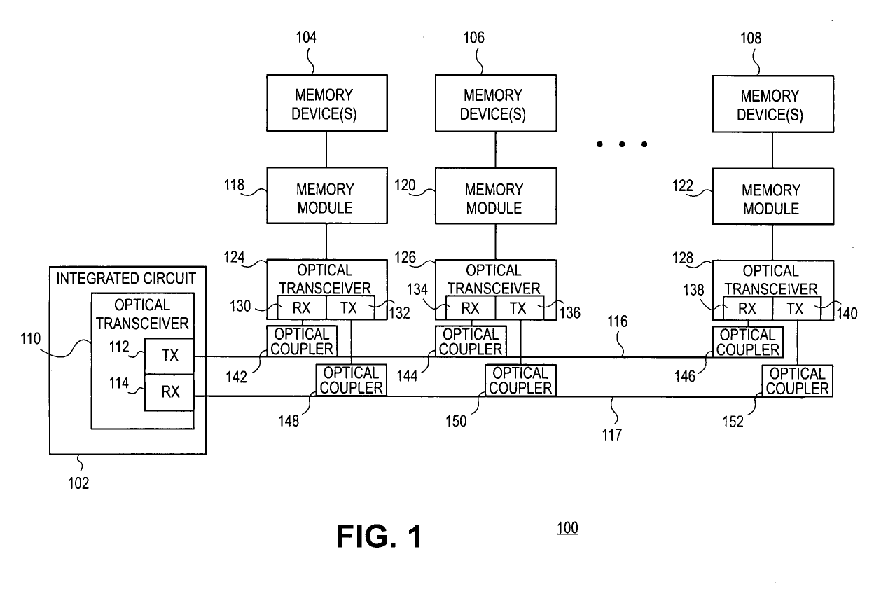

FIG. 1 is a high level schematic diagram of a memory subsystem 100 according to an embodiment of the present invention. The memory subsystem 100 includes an integrated circuit 102 to communicate with one or more memory devices, such as the memory devices 104, 106, and 108. In the illustrated embodiment, the integrated circuit 102 includes an optical transceiver 110, which includes an optical transmitter 112 and an optical receiver 114. The optical transmitter 112 is coupled to an optical bus 116 and the optical receiver 114 is coupled to an optical bus 117.

In the illustrated embodiment, the memory devices 104, 106, and 108 are coupled to memory modules 118, 120, and 122, respectively. The memory modules 118, 120, and 122 are coupled to optical transceivers 124, 126, and 128, respectively. The optical transceiver 124 includes an optical receiver 130 and an optical transmitter 132. The optical transceiver 126 includes an optical receiver 134 and an optical transmitter 136. The optical transceiver 128 includes an optical receiver 138 and an optical transmitter 140. The optical receivers 130, 134, and 138 are coupled to the optical bus 116 via the optical couplers 142, 144, and 146, respectively. The optical transmitters 132, 136, and 140 are coupled to the optical bus 117 via the optical couplers 148, 150, and 152, respectively.

The integrated circuit 102 may be any device to communicate with the memory devices 104, 106, and 108. In one embodiment, the integrated circuit 102 may be a processor. In this embodiment, the integrated circuit 102 may be any suitable device that performs functions of executing programming instructions including implementing embodiments of the present invention. For example, the integrated circuit 102 can be a processor of the Pentium® processor family available from Intel Corporation of Santa Clara, Calif. The processor may read from the memory devices 104, 106, and 108 and/or write to the memory devices 104, 106, and 108.

In an alternative embodiment, the integrated circuit 102 may be a memory controller. For example, the integrated circuit 102 may perform functions of controlling and monitoring the status of the data lines, error checking, etc., for the memory devices 104, 106, and 108 when other devices are attempting to read from the memory devices 104, 106, and 108 and/or write to the memory devices 104, 106, and 108.

The memory devices 104, 106, and 108 may be any suitable memory that performs the functions of storing data (pixels, frames, audio, video, etc.) and software (control logic, instructions, code, computer programs, etc.) for access by other components. The memory devices 1104, 106, and 108 are not limited to any particular type of memory device. In embodiments of the present invention, the memory devices 104, 106, and 108 may be any known read-only memory (ROM), dynamic random access memory (DRAM), static RAM (SRAM), flash memory, etc. After reading the description herein, a person of ordinary skill in the relevant art will readily recognize how to implement embodiments of the present invention for various other types of memory devices.

In one embodiment, the optical transceiver 110 may be a discrete component packaged and/or bonded with the integrated circuit 102. In an alternative embodiment, the optical transceiver 110 may be integrated with the integrated circuit 102 as a single package or single chip.

The optical transmitter 112 may be any suitable optical transmitter that performs the function of accepting an electrical signal as its input, processing the electrical signal, and using the processed electrical signal to modulate an opto-electronic device, such as a light emitting diode (LED) or a laser, to produce an optical signal capable of being transmitted on a transmission medium. A suitable optical transmitter may include a diode laser, a semiconductor laser, a vertical cavity surface emitting laser (VCSEL), an external cavity laser (ECL), or other suitable optical transmitter. The optical transmitters 132, 136, and 140 may be similar to the optical transmitter 112.

The optical receiver 114 may be any suitable optical receiver that performs functions of detecting an optical signal, converting the optical signal to an electrical signal, amplification, clock recovery, filtering, and/or further electrical signal processing. A suitable optical receiver may include a P-I-N detector, an avalanche photodiode, or other optical receiver. The optical receivers 130, 134, and 138 may be similar to the optical receiver 114.

The physical layer (PHY) of the optical buses 116 and/or 117 may be any suitable transmission media that perform the function of propagating optical signals from one point to another. In one embodiment, the optical buses 116 and/or 117 may include optical fiber as a transmission medium. The optical fiber may reside on the same printed circuit board (PCB) that the integrated circuit 102 resides and couple to the integrated circuit 102 through a conventional telecommunication optical connector, for example. The optical fiber may be integrated into the PCB or be routed as a free optical cable.

In an alternative embodiment, the optical buses 116 and/or 117 may include optical waveguide(s) as a transmission medium.

In still another embodiment, the optical buses 116 and/or 117 may include free space as a transmission medium. In this embodiment, the integrated circuit 102 may be aligned to and have clear line of sight with the optical couplers 142, 144, 146, 148, 150, and 152.

The memory modules 118, 120, and 122 may be a small printed circuit board (PCB) into which memory devices, such as the memory devices 104, 106, and 108, may be inserted. The memory modules 118, 120, and 122 are not limited to any particular type of memory module. In one embodiment, the memory modules 118, 120, and 122 are dual in-line memory modules (DIMMs). In another embodiment, the memory modules 118, 120, and 122 are single in-line memory modules (SIMMs). After reading the description herein, a person of ordinary skill in the relevant art will readily recognize how to implement embodiments of the present invention for various other types of memory modules.

The optical couplers 142, 144, and 146 may be any suitable optical couplers that perform the function of coupling all or a fraction of an optical signal from the optical bus 116 to the optical transceivers 124, 126, and/or 128. In an embodiment in which the optical bus 116 is a waveguide and the optical couplers 142, 144, and 146 are directional coupler waveguides (i.e., evanescent couplers), the optical couplers 142, 144, and 146 are brought in close proximity with the optical bus 116.

The evanescent tail propagating in the optical bus 116 partially falls within the optical couplers 142, 144, and 146 while an optical signal is propagating in the optical bus 116. The evanescent tail falling within the optical couplers 142, 144, and 146 excites optical waves in the optical couplers 142, 144, and 146 and power is gradually transferred from the optical bus 116 to the optical couplers 142, 144, and 146. The fraction of power transferred from the optical bus 116 to the optical couplers 142, 144, and 146 may be determined by tailoring the interaction length of the optical bus 116 and the optical couplers 142, 144, and 146 and the distance between them.

For example, the interaction length can be tailored so that if there are N optical couplers on the optical bus 116, one Nth of the optical signal (where N is the number of memory modules in the memory subsystem) is coupled into each optical coupler to its associated optical transceiver. That is, if there are four optical couplers on the optical bus 116, twenty-five percent of an optical signal propagating in the optical bus 116 will couple into each evanescent coupler and on to its associated optical transceiver. The last evanescent coupler couples off the remaining power in the optical signal.

In an alternative embodiment, the optical couplers 142, 144, and 146 may be beam splitters. Each beam splitter may direct a fraction (e.g., one Nth) of an optical signal propagating in the optical bus 116 to its associated optical transceiver. The remaining power in the optical signal passes through to the next beam splitter, which directs a fraction (e.g., one Nth) of an optical signal propagating in the optical bus 116 to its associated optical transceiver. The last beam splitter directs the remaining power in the optical signal propagating in the optical bus 116 to its associated optical transceiver.

In still another embodiment, the optical couplers 142, 144, and 146 may be optical fibers. Each optical fiber may couple a fraction (e.g., one Nth) of an optical signal propagating in the optical bus 116 to its associated optical transceiver. The next optical fiber couples a fraction (e.g., one Nth) of an optical signal propagating in the optical bus 116 to its associated optical transceiver. The last optical fiber directs the remaining power in the optical signal propagating in the optical bus 116 to its associated optical transceiver.

The optical couplers 148, 150, and 152 may be any suitable optical couplers that perform the function of coupling an optical signal from the optical transceivers 124, 126, and/or 128 to the optical bus 117. In an embodiment in which the optical bus 117 is a waveguide and the optical couplers 148, 150, and 152 are waveguides (e.g., evanescent couplers), the optical couplers 148, 150, and 152 are brought in close proximity with the optical bus 117.

The evanescent tail propagating in the optical couplers 148, 150, and 152 partially falls within the optical bus 117 while optical signals are propagating in the optical couplers 148, 150, and 152. The evanescent tail falling within the optical bus 117 excites optical waves in the optical bus 117 and power is gradually transferred from the optical couplers 148, 150, and 152 to the optical bus 117. In one embodiment, the optical couplers 142, 144, and 146 may be optical fibers coupled to the optical bus 117.

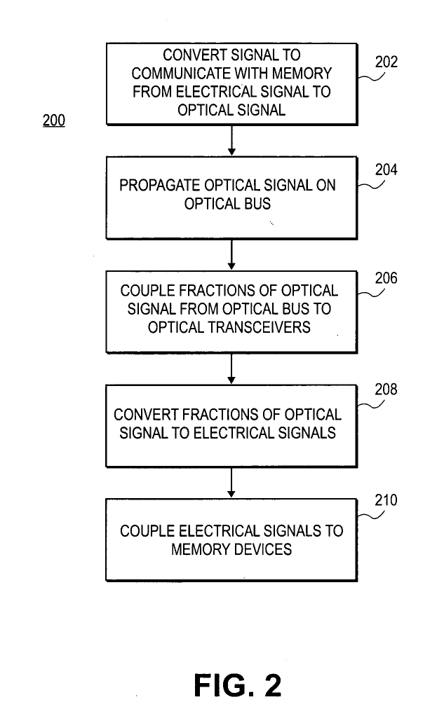

FIG. 2 is a flowchart illustrating a process 200 for operating the memory subsystem 100 according to an embodiment of the present invention, in which the integrated circuit 102 is transmitting to the memory devices 104, 106, and 108. The integrated circuit 102 may be performing a read request or a write request in which it may send control signals and/or data on electrical signals to the optical transceiver 110. Alternatively, the integrated circuit 102 may be writing to the memory devices 104, 106, and 108, in which case it may send data on electrical signals to the optical transceiver 110.

The operations of the process 200 are described as multiple discrete blocks performed in turn in a manner that is most helpful in understanding embodiments of the invention. However, the order in which they are described should not be construed to imply that these operations are necessarily order dependent or that the operations be performed in the order in which the blocks are presented.

Of course, the process 200 is only an example process and other processes may be used to implement embodiments of the present invention. A machine-accessible medium with machine-readable instructions thereon may be used to cause a machine (e.g., a processor) to perform the process 200.

In a block 202, the optical transceiver 110 converts the electrical signal to an optical signal.

In a block 204, the optical bus 116 propagates the optical signal.

In a block 206, the optical coupler 142 couples one-Nth of the optical signal propagating in the optical bus 116 to the optical receiver 130, the optical coupler 144 couples one-Nth of the optical signal propagating in the optical bus 116 to the optical receiver 134, and the optical coupler 146 couples the last one-Nth of the optical signal propagating in the optical bus 116 to the optical receiver 138.

In a block 208, the optical transceiver 124 converts its one-Nth of the optical signal to an electrical signal, the optical transceiver 126 converts its one-Nth of the optical signal to an electrical signal, and the optical transceiver 128 converts its one-Nth of the optical signal to an electrical signal.

In a block 210, the memory module 118 couples its electrical signal to the memory device 104, the memory module 120 couples its electrical signal to the memory device 106, and the memory module 122 couples its electrical signal to the memory device 108. In one embodiment, the memory devices 104, 106, and 108 may respond to the electrical signals by acknowledging the read request or write request, or, if appropriate, by storing the data included on the electrical signals.

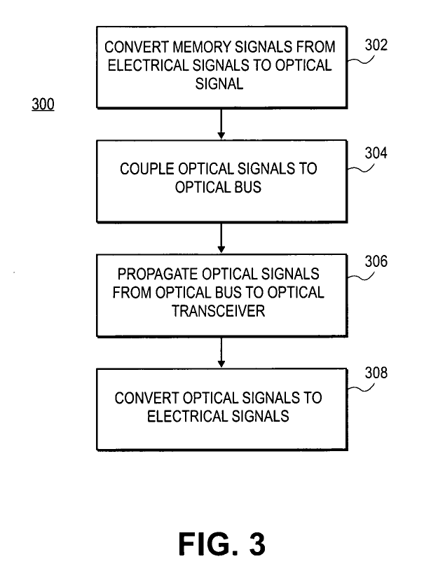

FIG. 3 is a flowchart illustrating a process 300 for operating the memory subsystem 100 according to an embodiment of the present invention, in which the memory devices 104, 106, and 108 are transmitting to the integrated circuit 102. The memory devices 104, 106, and 108 may be responding to a read request or write request from the integrated circuit 102 in which case it sends control signals and/or data on electrical signals to the optical transceiver 124.

The operations of the process 300 are described as multiple discrete blocks performed in turn in a manner that is most helpful in understanding embodiments of the invention. However, the order in which they are described should not be construed to imply that these operations are necessarily order dependent or that the operations be performed in the order in which the blocks are presented.

Of course, the process 300 is only an example process and other processes may be used to implement embodiments of the present invention. A machine-accessible medium with machine-readable instructions thereon may be used to cause a machine (e.g., a processor) to perform the process 300.

In a block 302, the optical transceiver 124 converts the electrical signal from the memory 104 to an optical signal, the optical transceiver 126 converts the electrical signal from the memory 106 to an optical signal, and the optical transceiver 128 converts the electrical signal from the memory 108 to an optical signal.

In a block 304, the optical coupler 148 couples the optical signal from the optical transceiver 124 to the optical bus 117, the optical coupler 150 couples the optical signal from the optical transceiver 126 to the optical bus 117, and the optical coupler 152 couples the optical signal from the optical transceiver 128 to the optical bus 117.

In a block 306, the optical bus 117 propagates the optical signals from the optical couplers 148, 150, and 150 to the optical transceiver 110.

In a block 308, the optical transceiver 110 converts the optical signals to electrical signals. In one embodiment, the integrated circuit 102 may respond to the electrical signals by reading the data included on the electrical signals.

The use of multiple memory modules according to embodiments of the present invention allows the memory subsystem 100 to support high-speed operations. The use of optical couplers 142, 144, 146, 148, 150, and 152 eliminates the impedance mismatch found in conventional memory subsystems. This is because although there are multiple memory modules that are plugged into the optical bus 116 or 117, using optical frequencies as the carrier permits the use of waveguides to couple a fraction of the light while managing the reflections and maintaining signal integrity. As a result, electrical noise and time delays due to signal reflections may be eliminated.

Because impedance mismatch has been eliminated using embodiments of the present invention, the memory modules do not have to be buffered to compensate for impedance discontinuities. As a result latency issues caused by such buffering have been eliminated as well (e.g., latency caused by having to wait for data to be read into one memory module before being read into a subsequent memory module). There may be added latency associated with the optical-to-electrical and electrical-to-optical conversions, but this latency can be kept low (relative to that of buffering) with appropriate transceiver devices and circuits.

General latency issues also have been eliminated by the use of optical couplers according to embodiments of the present invention. This is because coupling off portions of optical power in an optical signal propagating in the optical bus 116 or 117 does not impact the optical signal going through to the next optical transceiver and its associated memory module. This means that the memory subsystem 100 does not have to wait for data to be read into on memory module before being read into the next memory module.

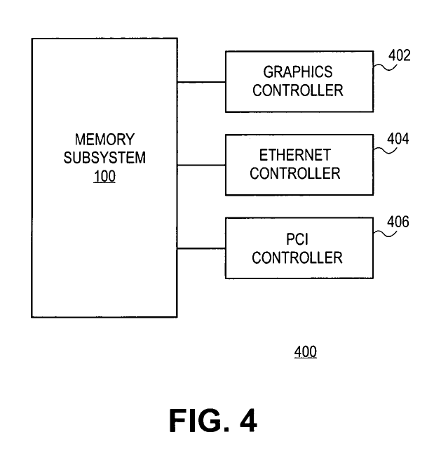

FIG. 4 is a high-level block diagram of a computer system 400 according to an embodiment of the present invention. In the illustrated embodiment, the computer system 400 includes the memory subsystem 100. The example computer system 400 is coupled to a graphics controller 402, an Ethernet controller 404, and a peripheral component interface (PCI) controller 408.

The graphics controller 402 performs its conventional functions of receiving commands and data and generating display signals (e.g., in RGB format). Graphics controller technology also is well known.

The Ethernet controller 404 performs its conventional functions of connecting peripheral devices to an Ethernet bus or cable. Ethernet controller technology is well known.

The PCI controller 406 performs its conventional functions of interfacing the memory subsystem 102 to a PCI bus hierarchy. PCI controller technology is well known.

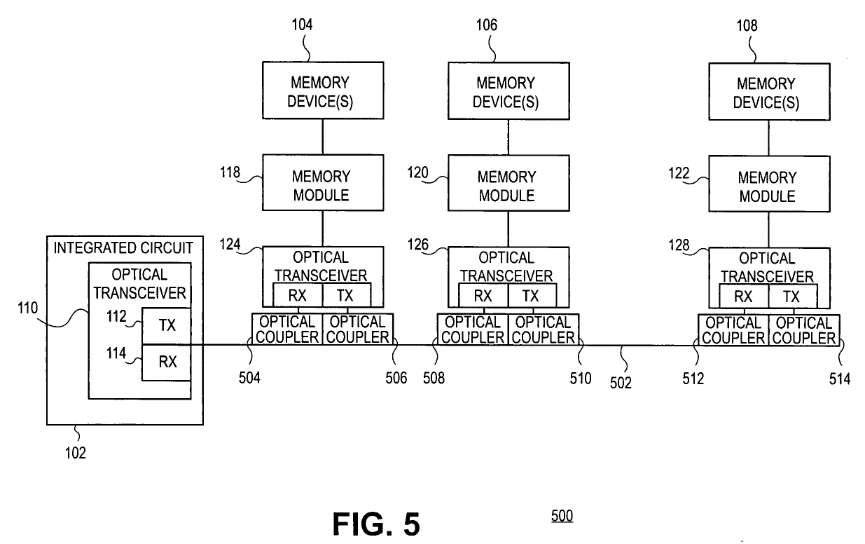

Although embodiments of the present invention have been described with respect to two unidirectional optical buses 116 and 117, embodiments of the present invention are not so limited. For example, FIG. 5 is a high level schematic diagram of a memory subsystem 500 according to an alternative embodiment of the present invention in which a bi-directional optical bus 502 is implemented.

In one embodiment, the optical signal propagating to the optical transceivers 124, 126, and 128 travel on the optical bus 502 along with the optical signals propagating to the optical transceiver 110. The optical couplers 504, 506, 508, 510, 512, and 514 can be optimized for each direction. Optical isolation may be implemented as well using an asymmetric coupler, for example. After reading the description herein, a person of ordinary skill in the relevant art will readily recognize how to implement embodiments of the present invention using such/a bi-directional bus.

In an alternative embodiment, there may be a separate optical bus coupled between the integrated circuit 102 and each memory module 118, 120, and 122. After reading the description herein, a person of ordinary skill in the relevant art will readily recognize how to implement embodiments of the present invention using a separate bus for each memory module.

Embodiments of the present invention may be implemented using hardware, software, or a combination thereof. In implementations using software, the software may be stored on a machine-accessible medium.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), as well as electrical, optical, acoustic, or other form of propagated signals (e.g., carrier waves, infrared signals, digital signals, etc.).

The above description of illustrated embodiments of the invention is not intended to be exhaustive or to limit embodiments of the invention to the precise forms disclosed. While specific embodiments of, and examples for, the invention are described herein for illustrative purposes, various equivalent modifications are possible within the scope of embodiments of the invention, as those skilled in the relevant art will recognize. These modifications can be made to the embodiments of the invention in light of the above detailed description.

In the above description, numerous specific details, such as particular processes, materials, devices, and so forth, are presented to provide a thorough understanding of embodiments of the invention. One skilled in the relevant art will recognize, however, that the embodiments of the present invention can be practiced without one or more of the specific details, or with other methods, components, etc. In other instances, well-known structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

1. An apparatus, comprising:
an integrated circuit to communicate with a memory, the integrated circuit having an optical transmitter;
an optical bus coupled to the optical transmitter;
N optical receivers coupled to the optical bus via N optical couplers;
N memory modules coupled to the N optical receivers; and
one or more memory devices coupled to the N memory modules, the optical transmitter to convert a signal to communicate with the memory devices from a first electrical signal to an optical signal, the optical bus to propagate the optical signal, each of the N optical couplers to couple one-Nth of the optical signal from the optical bus to its associated optical receiver, each optical receiver to convert its one-Nth of the optical signal to second set of electrical signals, the N memory modules to couple the second set of electrical signals to the memory devices.

2. The apparatus of claim 1, wherein the integrated circuit is a memory controller.

3. The apparatus of claim 1, wherein the integrated circuit is a processor.

4. The apparatus of claim 1, wherein the optical bus includes at least one of a waveguide, optical fiber, or free space.

5. The apparatus of claim 1, wherein the optical transmitter includes a laser.

6. The apparatus of claim 1, wherein the couplers are directional couplers.

7. The apparatus of claim 6, wherein the directional couplers include a waveguide or an optical fiber.

8. The apparatus of claim 1, wherein the couplers are free space couplers.

9. The apparatus of claim 8, wherein the free space couplers are beam splitters.

10. An article of manufacture, comprising a machine-accessible medium including data that, when accessed by a machine, cause the machine to perform the operations comprising:
converting a signal to communicate with memory devices from a first electrical signal to an optical signal;
propagating the optical signal on an optical bus to N optical couplers;
coupling one-Nth of the optical signal from the optical bus to each one of N optical receivers;
each optical receiver converting its one-Nth of the optical signal to a second set of electrical signals; and
coupling the second set of electrical signals to one or more memory devices via N memory modules.

11. The apparatus of claim 10, wherein the machine-accessible medium further includes data that cause the machine to perform operations comprising propagating the optical signal on a waveguide or optical fiber.

12. The apparatus of claim 11, wherein the machine-accessible medium further includes data that cause the machine to perform operations comprising coupling one-Nth of the optical signal from the optical bus to each one of N optical receivers via a directional coupler.

13. The apparatus of claim 10, wherein the machine-accessible medium further includes data that cause the machine to perform operations comprising propagating the optical signal via free space.

14. The apparatus of claim 13, wherein the machine-accessible medium further includes data that cause the machine to perform operations comprising coupling one-Nth of the optical signal from the optical bus to each one of N optical receivers via a beam splitter.

15. An apparatus, comprising:
one or more memory devices to communicate with an integrated circuit, the integrated circuit having an optical receiver;
N memory modules coupled to the memory devices;
N optical transmitters coupled to the N memory modules; and
an optical bus coupled to the optical receiver,
each of the N optical transmitters to convert a signal to communicate with the integrated circuit from an electrical signal to an optical signal, the optical bus to propagate the optical signals to the optical receiver, the optical receiver to convert the optical signals to electrical signals.

16. The apparatus of claim 15, wherein the integrated circuit is a memory controller.

17. The apparatus of claim 15, wherein the integrated circuit is a processor.

18. The apparatus of claim 15, wherein the optical bus includes at least one of a waveguide, optical fiber, or free space.

19. The apparatus of claim 15, wherein the optical receiver includes a photodetector.

20. The apparatus of claim 15, wherein the couplers are directional couplers.

21. The apparatus of claim 20, wherein the directional couplers include a waveguide or an optical fiber.

22. A system, comprising:
an integrated circuit to communicate with a memory, the integrated circuit having an optical transmitter, an optical bus coupled to the optical transmitter, N optical receivers coupled to the optical bus via N optical couplers, N memory modules coupled to the N optical receivers, and one or more memory devices coupled to the N memory modules, the optical transmitter to convert a signal to communicate with the memory devices from a first electrical signal to an optical signal, the optical bus to propagate the optical signal, each of the N optical couplers to couple one-Nth of the optical signal from the optical bus to its associated optical receiver, each optical receiver to convert its one-Nth of the optical signal to second set of electrical signals, the N memory modules to couple the second set of electrical signals to the memory devices; and
a graphics controller coupled to the integrated circuit.

23. The system of claim 22, wherein the integrated circuit is a memory controller.

24. The system of claim 22, wherein the integrated circuit is a processor.

25. A system, comprising:
one or more memory devices to communicate with an integrated circuit, the integrated circuit having an optical receiver, N memory modules coupled to the memory devices, N optical transmitters coupled to the N memory modules, and an optical bus coupled to the optical receiver, each of the N optical transmitters to convert a signal to communicate with the integrated circuit from an electrical signal to an optical signal, the optical bus to propagate the optical signals to the optical receiver, the optical receiver to convert the optical signals to electrical signals; and
a graphics controller coupled to the integrated circuit.

26. The system of claim 25, wherein the integrated circuit is a memory controller.

27. The system of claim 25, wherein the integrated circuit is a processor.
